(19) United States
(12) Patent Application Publication
(10) Pub. No.: US 2008/0233653 A1
(43) Pub. Date: Sep. 25, 2008

(54) System and Method for Processing Chemical Substances, Computer Program for Controlling Such System, and a Corresponding Computer-Readable Storage Medium

(75) Inventors: Andre Hess, Berlin (DE); Roger Knopp, Berlin (DE); Thomas Burde, Schoenerlinde (DE); Frank Steinke, Berlin (DE)

Correspondence Address: NORRIS, MCLAUGHLIN & MARCUS, P.A., 875 THIRD AVE, 18TH FLOOR, NEW YORK, NY, 10022, US

(73) Assignee: ECKERT & ZIEGLER EUROTOPE GMBH, Berlin (DE)

(21) Appl. No.: 11/817,840

(22) PCT Filed: Jun. 1, 2006
(86) PCT No.: PCT/EP06/62850

§ 371 Date: Sep. 5, 2007

(30) Foreign Application Priority Data
Jun. 17, 2005 (DE) 102005028897.9-43

(51) Int. Cl. G01N 35/00; B01J 19/00

(52) U.S. Cl. 436/43; 422/68.1

(57) ABSTRACT

The invention is directed to a system and a method for processing chemical substances, a computer program for controlling such system, and a corresponding computer-readable storage medium, which can be used, in particular, to flexibly adapt synthesis devices, in particular for radioactive chemicals or radioactive pharmaceutical products, to different process flows and to make the synthesis devices usable for research and routine operation.

To this end, a system for processing chemical substances in a laboratory setting is proposed, wherein the system includes components for carrying out basic chemical processing operations. The components can be modularly combined according to presettable sequences of process steps for processing chemical substances and have matching modular dimensions. The components can also be implemented as stackable, self-supporting boxes.

The invention relates to a system and a method for processing chemical substances, a computer program for controlling such system, and a corresponding computer-readable storage medium, which can be used, in particular, to flexibly adapt synthesis devices, in particular for radioactive chemicals or radioactive pharmaceutical products, to different process flows and to make the synthesis devices usable for research and routine operation.

A number of chemical process steps, generally referred to as unit operations, are employed in the synthesis of radioactive chemicals and more particular radioactive pharmaceutical products. Such unit operations are, for example, extraction, heating/cooling, mixing, diluting, metering, etc.

Ideally, almost all chemical syntheses and physical process steps can be divided into such unit operations. While the unit operations can be found in medium and large scale facilities in the form of large-scale components, this approach has to date only rarely been used on a laboratory scale and in particular for radioactive pharmaceutical products. In pharmaceutical products, the so-called PET (positron emission tomography) tracers must typically go through complex chemical process steps before arriving at the end product. However, process steps such as mixing, diluting, boiling, etc., must also be performed before kits preassembled by a manufacturer can be used and applied. However, most often complete systems have been installed to date which are only capable of executing a single defined synthesis path, i.e., only a single defined set of process steps.

For example, conventional synthesis devices are used for automatic and remotely controlled production of chemical substances, such as radioactive diagnostic and pharmaceutical products. They are used particularly in the synthesis of PET tracers, for example F18-FDG. A short-lived radionuclide produced in a cyclotron is herein coupled to a biomolecule which can then be injected into the human body for a PET examination.

PET examinations can be used to draw high-resolution diagnostic conclusions about the metabolism of, for example, tumor cells. The method has become increasingly important not only for the early detection of cancer, but also for testing the effectiveness of cancer therapy. If PET is combined with CT (=computer tomography), then the high-resolution information about the metabolism is linked directly with anatomical information, which offers outstanding opportunities for diagnosing tumors.

Due to the short half-life of the PET nuclides (F-18: 110 minutes, C-11: 20 minutes), radio-chemical laboratories that perform the additional synthesis steps must be set up in the immediate vicinity of cyclotrons. The available time is very short, so that for example, quality checks are performed on the produced product while the product is already on its way to the patient. Another reason why automation is essential is the significant emission of radiation from the nuclides, which make manual operation infeasible.

Currently, only highly specialized devices are on the market, almost one special synthesis device for each PET tracer, which does not allow the user to make changes and perform upgrades or to retool for an entirely different reaction path.

Existing concepts also emphasize either the use as an aseptic routine production device employing predetermined sterile single-use materials, which can then not satisfy the flexibility required for process development or research; alternatively, an aseptic routine operation employing devices that use reusable flow-through components can either not obtain certification from regulatory authorities, or validation of the cleaning process is associated with significant expenses.

There are no conventional systems available that satisfy both requirements for a user.

In the area of radioactive materials, solutions must also be provided for automatic and semiautomatic filling of the radioactive pharmaceutical products. Particular attention has to be paid to the different requirements in the EU and US markets. Currently, a few solutions exist which, however, cannot be viewed as an integrated concept. In another situation, the offered filling system is designed for large-scale pharmaceutical manufacturing and therefore completely ignores the interests and budgetary requirements of small and midsize PET laboratories. In addition, the device software does not communicate with the control software of the upstream synthesis devices.

The state of the art in the area of (radioactive) pharmaceutical synthesis and filling devices is therefore characterized in that, although automated solutions for specific synthesis devices exist, there are no integrated solutions which also include the downstream filling process.

For example, automated synthesis devices are provided for producing one of the conventional PET tracers, such as 18-F-FDG. Specialized devices are also offered for either
routine-FDG 18F syntheses or
DOPA 18F syntheses or
nucleophilic F-18 syntheses or
electrophilic F-18 syntheses or
[11C] methyl-iodide and methylations.

The available systems generally encompass dedicated systems for a defined synthesis.

The conventional solutions have, inter alia, the following disadvantages:
existing concepts are tied to predefined syntheses,
multi-functional synthesis control is either not possible at all or only in a limited fashion,
possibilities for having the user modify the software and the system are inadequate and extremely time-consuming.

The existing software solutions thus depend on the existing hardware implementation and are used—exclusively—for controlling the hardware. Unknown are options for expansion, future unrestricted reprogramming or use of the existing base for a pharmaceutical, GMP-conforming synthesis of entirely new radioactive tracers (GMP=Good Manufacturing Practice).

With respect to the subsequent process steps sterile filtration, filling, metering, labeling and packaging, no implemented hardware systems are compatible with or controllable by the same software.

This situation forces users of PET synthesis devices, due to the limited commercial availability of suitable solutions, to acquire for each PET tracer a specialized synthesis device at a high cost, wherein the device can then only be used for routine production and is either completely unsuitable for other applications or can only be employed with great difficulty. It is difficult to obtain regulatory approval for other types of systems for sterile operation. Because many users do not have adequate funding to acquire such assortment of devices, one frequently encounters one-of-a-kind device implementations, where a highly trained radio-pharmacologist spends valuable time performing a necessary unplanned conversion of old systems or tries to get by with other improvised manual solutions.

Several proposals have been made for dealing with partial aspects of this problem. For example, the published US Patent Application Serial No. 2004/0028573 A1 describes a device for the synthesis of radioactive pharmaceutical products which are based on chemical reagents contained in flasks, wherein the device includes the following: a variety of reaction chambers, transfer elements between the flasks and the reaction chambers, as well as mechanical elements for monitoring and mechanically controlling the transfer of the chemical components. To prevent contamination of one synthesis by another preceding synthesis, the patent application proposes to implement the transfer elements as removable elements which can be removed and optionally discarded after use.

The international patent application WO 01/85735 A2 discloses an apparatus for processing radionuclides which generally includes a reaction vessel and a block, wherein the block includes a container for receiving a vessel, an upper element and a lower element for changing the temperature. To achieve the fastest possible temperature changes, the container that receives the vessel forms an upper zone and a lower zone and is configured to receive the reaction vessel therein, defining in the upper zone an upper zone space between an exterior side of the reaction vessel and an inner wall of the vessel-receiving container. Likewise, a lower zone space is defined in the lower zone between an exterior side of the reaction vessel and an inner wall of the vessel-receiving container. The upper element for changing the temperature is used to change the gas temperature in the upper zone space, and the lower element for changing the temperature is used for changing the gas temperature in the aforementioned lower zone space. Special reactor receiving members are described which include a two-zone temperature control using hot and cold air, respectively.

US Patent Application Serial No. 2004/0022696 A1 describes a method for producing multiple batches of a radiopharmaceutical, for example FDG (FDG=fluoro-deoxyglucose). The method includes the steps of: transferring the appropriate liquids to a production apparatus, processing the liquids to produce the radiopharmaceutical, delivering the radiopharmaceutical to a container, automatically cleaning the apparatus, and repeating the previous steps, as desired. The apparatus for multi-batch production of FDG includes a reagent delivery system, a reaction vessel, a filter assembly, and a control system. Due to automatic (self) cleaning and automatic monitoring of the components, for example the membrane filters, the combination of these components provides a method that is capable of producing multiple batches of a radiopharmaceutical with minimal operator intervention and, consequently, minimal radiation exposure.

The international patent application WO 03/064678 A2 discloses a system for radioactive labeling of compounds with a labeling component which is connected with a component for delivering solvents, with a HPLC pump (HPLC=High Performance Liquid Chromatography), and with an HPLC column. The labeling component contains a loop and valves with different orientations (rotary loop valves) to provide different flow paths for the solvent, the radioactive labeling component and an inert gas through the system.

U.S. Pat. No. 5,932,178 proposes an FDG synthesizer with a simplified synthesis process and a shorter duration of the synthesis, with an improved yield of a synthesized product by using a column which is filled with a polymer-supported phase-transfer catalyst resin, which is obtained by attaching a phosphonium salt or a pyridinium salt to a polystyrene resin—instead of using a conventional labeling reaction vessel for carrying out a labeling reaction—, and by using a column which is filled with a cation-exchange resin—instead of a conventional reaction vessel for hydrolysis.

Although the solutions proposed to date provide individual devices with additional features for specific synthesis paths, these proposals do not solve the problem to use these devices for different synthesis paths.

It is therefore an object of the invention to provide an apparatus and a method for processing chemical substances, a computer program for controlling such apparatus, and a corresponding computer-readable storage medium, which obviate the aforedescribed shortcomings and, more particularly, enable an easy and flexible conversion of laboratory equipment which can then be used for different sequences of process steps.

The object is solved by the invention with the features recited in claims 1, 16, 22 and 28. Advantageous embodiments of the invention are recited in the dependent claims.

The apparatus of the invention for processing chemical substances in a laboratory setting, with components for carrying out basic chemical processing operations, has the particular advantage that it can be flexibly expanded and retrofitted in that the components can be combined in modular form according to presettable sequences of process steps for processing chemical substances. Moreover, the components have matching modular dimensions and/or include matching fittings/connections. The term modular combinability is used herein to indicate that the individual components can be freely combined with each other and also freely positioned. According to a preferred embodiment of the invention, the components are implemented as stackable, preferably rectangular, self-supporting boxes, wherein preferably a single basic chemical processing operation is realized in each box or module. According to another preferred embodiment, the components are provided with matching connecting elements, allowing a stable and releasable combination of the components. However, components can also be spaced apart from each other. The matching connecting elements enable a combination of the components to a standalone and self-supporting system, thereby obviating the need for a supporting wall typically used in conventional systems. These connecting elements can be, for example, elements that protrude from the surface of the component housing and corresponding recesses or openings. In one exemplary embodiment, the projecting elements are implemented as handles which facilitate transporting the components. Handles of a first component are received in corresponding openings in a second component when the system is assembled. In this way, the components can be plugged together as a modular plug-in system.

According to another preferred embodiment of the invention, each component may be configured to perform a basic chemical processing operation. These are independently operating components that are freely connectable with each other via an intelligent bus system, i.e., the sequential order in which the individual components combined to a system are interconnected is not predetermined, but can be freely selected. This has the advantage that, for example, fewer wires are required which facilitates cabling. The components preferably have their own internal logic and communicate with each other and with a central control unit (for example an industrial PC) via the intelligent bus system. The internal logic enables, for example, mutual registration and administration of components and processing of return signals.

According to another preferred embodiment of the invention, at least one motor, electronic unit and/or sensor are arranged in the housing of a component. According to yet another preferred embodiment of the invention, for example the valves of valve banks are arranged external to the housings. The individual components can advantageously be connected with standard single-use hoses. This has the advantage, for example, that sterilized single-use components can be employed, which are required in pharmaceutical aseptic operations.

The chemical substances to be processed can be, for example, radioactive substances, in particular pharmaceutical products and/or diagnostic products. In particular, the system of the invention can advantageously be employed when processing also includes the synthesis of chemical substances.

To ensure proper radiation shielding, radiochemical or radiopharmaceutical syntheses are frequently performed automatically. In a preferred embodiment of the invention, a remotely controlled modular system is provided which can be employed, in particular, for such radiochemical or radiopharmaceutical syntheses. In particular, the system can be used to perform syntheses or other operations in a (discontinuous) batch process, whereby initially the reactants are supplied and thereafter the supply of additional substances is discontinued. However, the system of the invention can in principle also be used for continuous operations.

The basic chemical processing operations may include, for example,
transport of vessels/syringes,
filtration,
heating/cooling,
filling, emptying and/or metering,
mixing,
diluting,
stirring and/or agitation,
extraction and/or ion exchange,
chromatography, in particular HPLC,
detection of product properties, such as pressure, temperature, activity, volume, refractive index, light absorption, etc.,
evaporating,
boiling,
rinsing and cleaning, and/or
generation of underpressure or overpressure.

According to another preferred embodiment of the system of the invention, the system can be configured to perform the process steps:
sterile filtration,
determination of the integrity of a sterile filter,
labeling,
packaging and/or
filling.

Advantageously, modular components may be available which are implemented as
valve module,
container module,
container transport module,
container agitation module,
cartridge module,
distribution module (for extraction, chromatography or filtration),
reactor module,
heater module,
metering module, for example a syringe module,
HPLC unit,
cold-trap module,
vacuum system or overpressure system,
filling module, or
analytic device.

According to another preferred embodiment of the system of the invention, components for filling may be combined with components for carrying out basic chemical processing operations.

According to another preferred embodiment of the system of the invention, the reactor cooling may be implemented as reactor cooling without using liquid nitrogen, wherein preferably purely electronic cooling using the Peltier effect can be used. Eliminating the conventional cooling with liquid nitrogen, which under sterile or radiation shielding conditions is very complex to implement, is particularly advantageous for radiopharmaceutical applications.

Advantageously, the components may be modularly combined in such way that components for carrying out basic chemical processing operations are exchangeable when replacing process steps in the sequence of process steps, and/or a system according to claim 1 can be expanded by adding at least one component for carrying out basic chemical processing operations when adding additional process steps to the sequence of process steps.

To further reduce the complexity of the configuration, the system may include an intelligent bus system which recognizes connected components. Advantageously, standard connecting cables can be employed which only differ by having different lengths.

With such intelligent bus system, the components can be connected freely in a linear arrangement, which advantageously provides a clearly defined wiring pattern with the shortest connections, depending on the arrangement of the components. With the intelligent bus system the wires can also be interrupted at any location to enable insertion of additional components, independent of their type. Moreover, fewer wires are required, simplifying cabling. According to a preferred embodiment of the invention, the components are provided with their own internal logic; this further enables processing of return signals.

With another measure for reducing the complexity of the configuration, preformatted program modules which control standard reactions can be integrated into the computer program for controlling the system of the invention.

In another embodiment, the connections are implemented as coded connecting cables which are connected to a receptacle strip on the control unit.

Depending on the employed substances, for quickly reconfiguring the system, at least a portion of the components may advantageously be combined with single-use elements, which may also eliminate the need for complex cleaning steps.

A method according to the invention for processing chemical substances is characterized in that the components are combined in modular form and configured according to a preset sequence of process steps for processing chemical substances, and that processing of the chemical substances is at least partially controlled by a computer program. Advantageously, configuration and control is performed with a common software user interface.

According to a preferred embodiment of the process of the invention, the computer program uses a uniform database for configuring the modularly combined components.

In the event of interruptions in the hardware or software, a started process flow can advantageously be completed manually. To this end, the computer program provides a mode for manual control of process flows.

For controlling the system of the invention, a computer program is advantageously employed which can be used for
configuring the components of the system,
programming the user interface, the process protocol and the control sequences,
operating the system,
monitoring processing,
storing and/or logging of data and/or
the administration.

In particular, data storage and/or data logging can advantageously be used to provide an audit trail and print reports, since the documentation of the process steps conforms to GMP, which is essential, in particular, for pharmaceutical test batches and routine production.

Advantageously, the computer program may include program modules for control, operation and/or display for components.

It can be advantageous for distributing the invention to provide the computer programs for downloading (fee-based or free of charge, freely accessible or password-protected) in a data of or communication network. The provided computer programs can be used with a method where a computer program according to claim 22 is downloaded from an electronic data network, for example from the Internet, to a data processing device connected to the data network. Alternatively or in addition, computer-readable storage media can be provided, where a computer program according to claim 22 or portions of a computer program according to claim 22 are stored.

The modular system described herein for the synthesis and filling of radiopharmaceutical products and chemicals represents an integrated system which is administered by a common software user interface. The user is confronted only with software that can be intuitively controlled by using a graphic symbols.

The system is not limited to use with PET tracers alone. It can also be employed in a general radiopharmaceutical setting as well as in research.

The modular system according to the invention is further differentiated by selective automated or user-specific operation, exceptional user friendliness and variability. In particular, the concept of flexibility should be mentioned, as well as the subsequent expandability, the creation of an integrated, graphic and easily understandable software user interface, and also a number of technical features, such as the liquid nitrogen free reactor cooling and the self-identifying components on the bus system.

Compared to systems and solutions known to date, the present concept is based on a new approach. It includes an integrated system with synthesis modules and an optional filling unit which can be used, in particular, in a radiopharmaceutical setting, which is managed by a common software user interface. The invention is based on flexibility, expandability, research and routine operation, single-use components and individual elements. This distinguishes the modular arrangements of the invention from conventional devices, which cannot be retrofitted at a later date with additional hardware components, such as reactors and the like, and especially not with software. The controllability of subsequent process steps, such as filling, etc., with software is unique for the proposed solution described herein.

In conventional devices, cooling processes are implemented via liquid nitrogen feed lines and subsequent electric heating. This enables rapid cooling, but requires a hot cell to be handled and replenished with liquid nitrogen on a regular basis inside an aseptic clean room area, which is considered to be highly problematic. Conversely, the present concept provides fully electric cooling elements, for example Peltier elements, which can be operated remotely in a cleanroom environment. According to a preferred embodiment of the reactor module of the invention, an internal thermometer is disposed in the reactor fluid for determining the actual temperature. Advantageously, a camera can also be integrated in the reactor module for monitoring the condition of the reactor vessel. A device for measuring selected properties of the employed reactants (educts) and or of the compound to be synthesized (product), for example a detector for measuring radioactivity, or measuring cells for UV or IR spectroscopy, can advantageously also be provided in the reactor module, or in other modules.

In a preferred embodiment of the invention, a squeeze-valve technique, preferably motor driven squeeze-valves, are employed. Advantageous hereby is in particular the use of a roller technique, which applies a very gentle load on the hose. In a preferred embodiment of the squeeze-valve technique, a pivotally supported roller may be pressed against a hose at a predetermined pivot angle, whereby the system can be adapted to variable hose diameters. In this way, the squeezing force can be adjusted, the maximal squeeze travel can be limited and/or interchangeable hose holders can be employed for different hose diameters. The squeeze-valves can be selected to be closed or open in the absence of a current.

In the system of the invention, the modules can be flexibly expanded and retrofitted. An intelligent bus system is provided to which the modular components, such as reactors, valves and the like, can be connected, which are then recognized by the system itself. This eliminates the need for cumbersome registration or hardware-specific programming of added or changed components. The actual extent of the configuration is always known to the software user interface.

According to another aspect of the flexibility concept, the system is not restricted to applications in the PET sector, but can be used in all radiopharmaceutical facilities. The system can also be used in research settings and at universities.

The modular system of the invention is therefore distinguished, inter alia, by freely exchangeable and interchangeable components. According to a particularly advantageous feature of the invention, the components can be freely positioned because of the modular box concept and need not be attached to other support members, such as support platforms. The modularity includes all components; in particular, for example, valves and vessel support assemblies also form modular, freely combinable components.

The invention is therefore far superior to the present state of the technology. This represents significant time and cost savings for the user.

Exemplary embodiments of the invention will now be described in more detail with reference to the figures of the appended drawings. It is shown in:

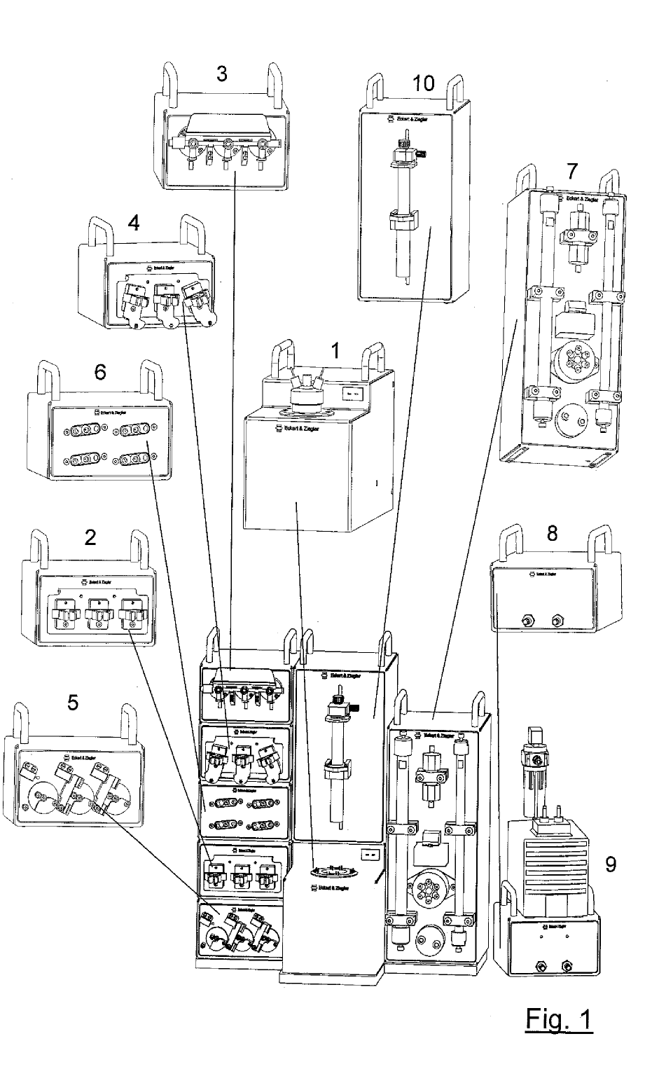

FIG. 1 a schematic diagram of a layout of a modular synthesis system: individual modules and assembled configuration in a front view,

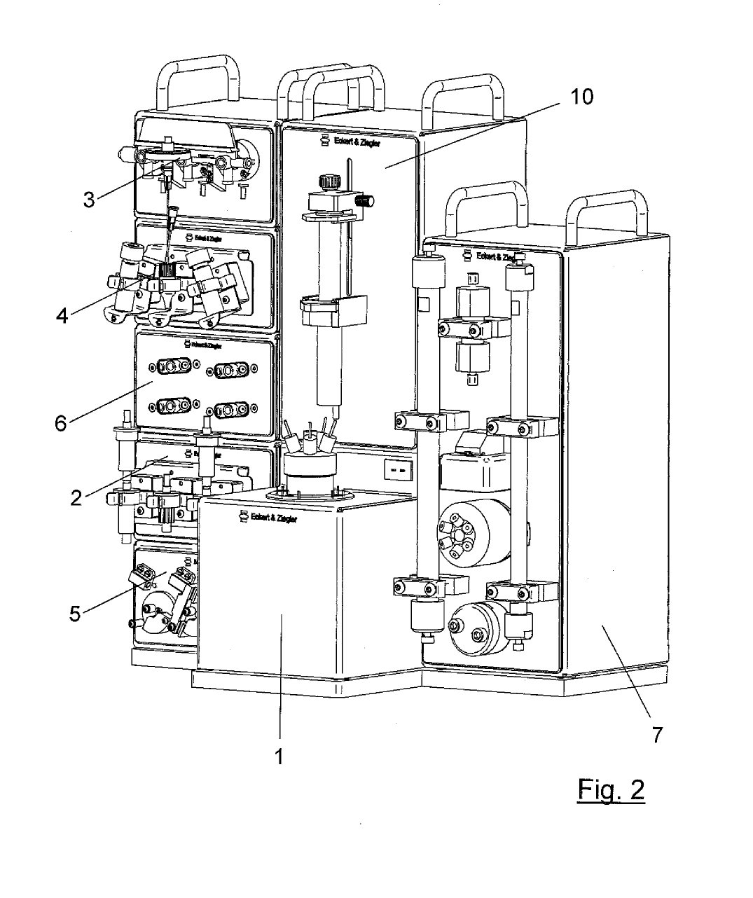

FIG. 2 a schematic diagram of the layout of a modular synthesis system in a perspective view,

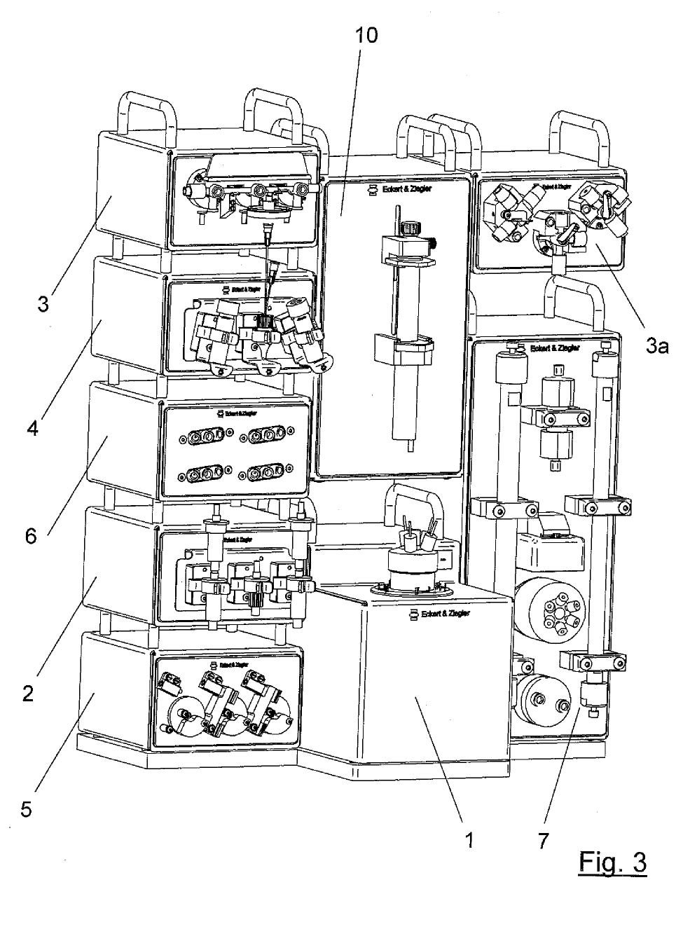

FIG. 3 a schematic diagram of the layout of a modular synthesis system in an exploded view,

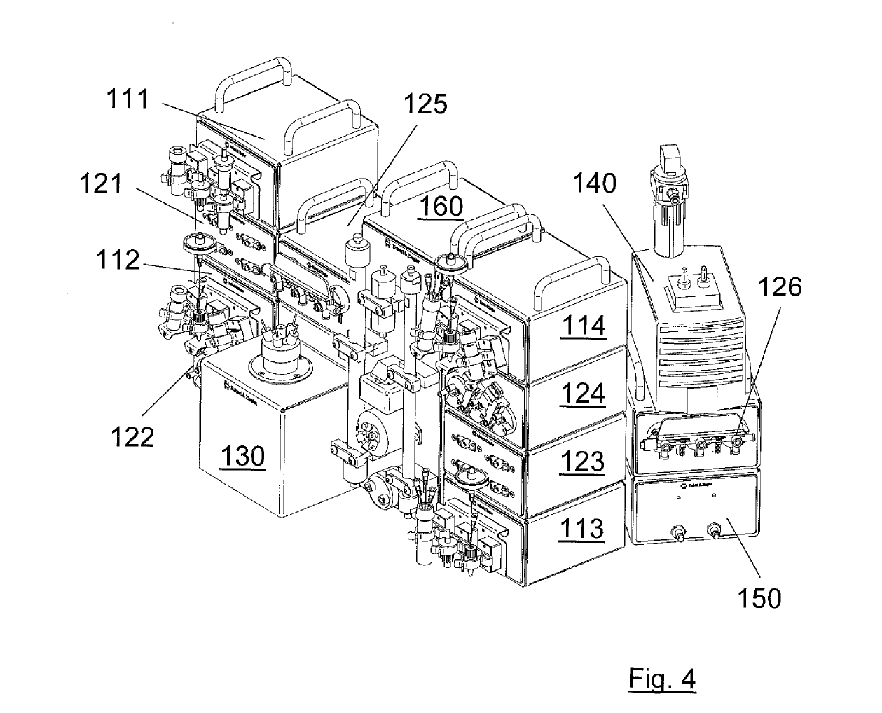

FIG. 4 a schematic diagram of the layout of a modular synthesis system for the production of ¹⁸F-FDG (2-deoxy-2-fluoro-D-glucose),

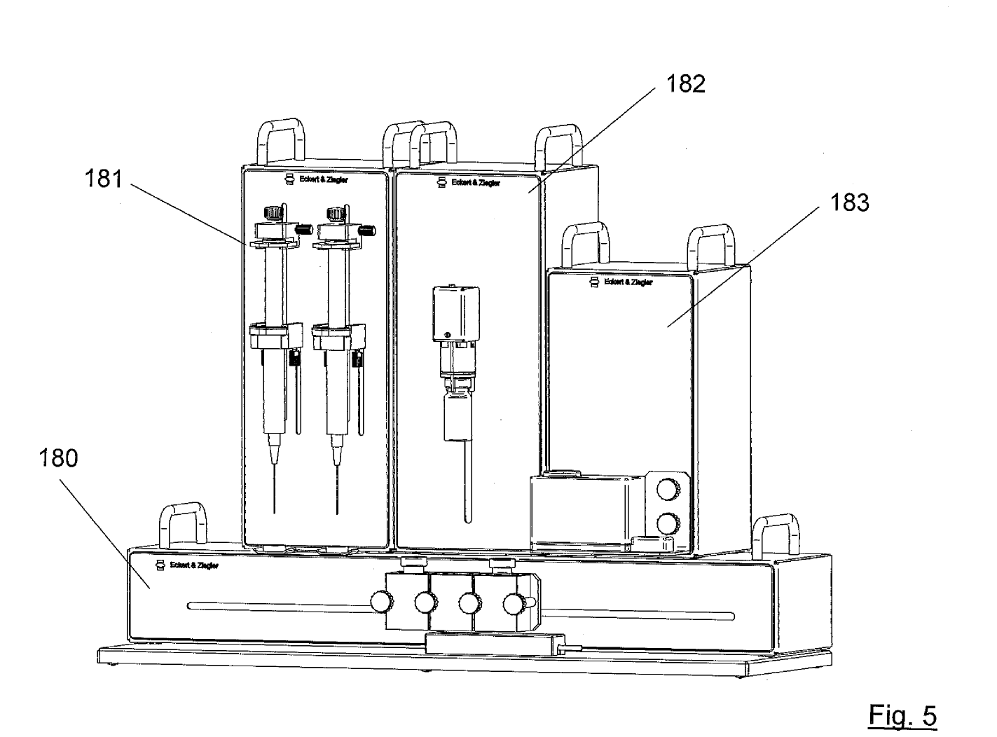

FIG. 5 a schematic diagram of the layout of a modular synthesis system for the preparation of Tc-99m-MIBI,

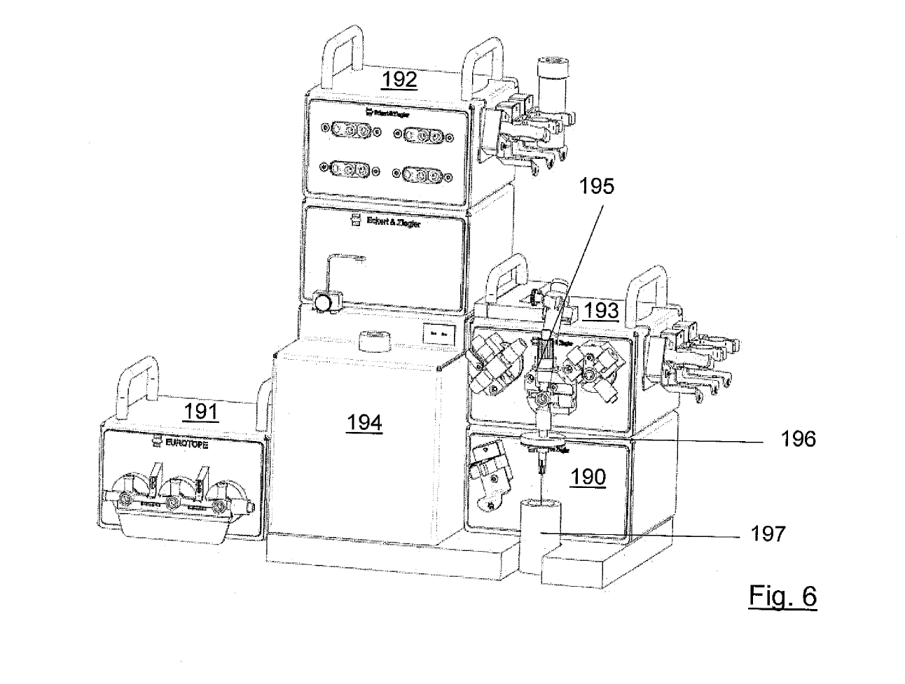

FIG. 6 a schematic diagram of the layout of a modular synthesis system for the production of 68Ga-DOTA conjugated peptides,

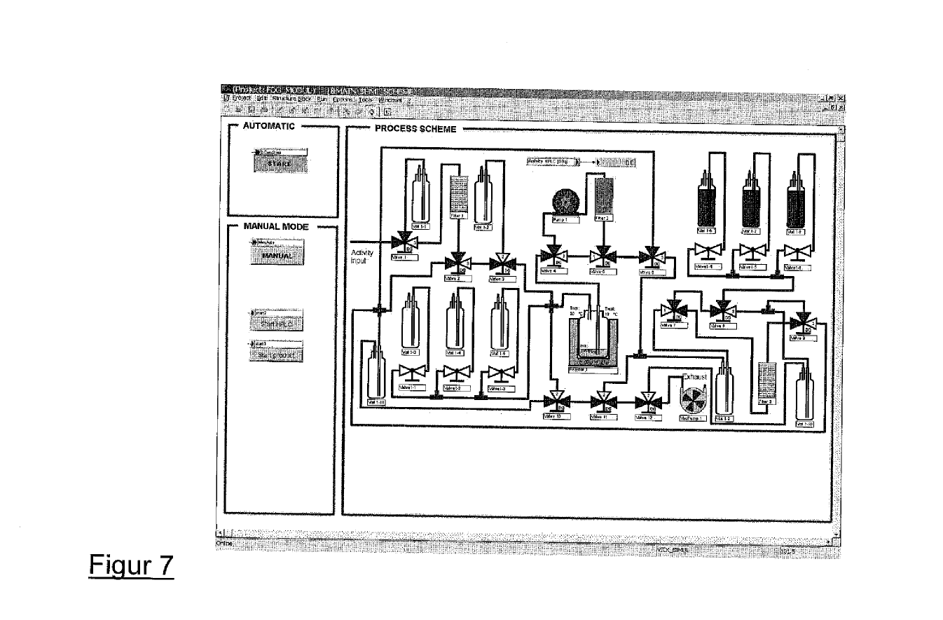

FIG. 7 a schematic diagram of an exemplary user interface with a visualization of the hardware configuration depicted in FIG. 1.

An exemplary modular system, as shown schematically in FIGS. 1-3, includes, among others, the following individual modules:

reactor module 1,
cartridge module 2 (chromatography, extraction or filtration cartridges),
Valve module in an embodiment valve bank 3,
vessel module 4 in an embodiment flask holder,
Valve module in an embodiment squeeze-valve 5,
valve module in an embodiment 3/2-way valve 6 and 6a, respectively,
accessory/analytic unit, here HPLC 7,
cold-trap module 8,
P vacuum/pressure system, here vacuum pump 9 with valves.

FIG. 4 shows the layout of a modular synthesis system for the production of, for example, ¹⁸F-FDG (2-deoxy-2-fluoro-D-glucose), wherein the depicted HPLC 160 is an optional accessory which is required only for other syntheses or with reconfigured process parameters.

FIG. 5 shows the layout of a modular synthesis system for the preparation of Tc-99m-MIBI. Any combination of individual modules is possible, the vessel transport module 180 can be used to both transport and hold the vessels. This module can be equipped with between three and five holders for different vessels. A linear axle is used for positioning the individual modules. The vessel transport module further includes a detector for checking the activity dose.

The syringe module 181—implemented here as a dual syringe module—is used to remove the fluids from one vessel and to add them to another vessel. The volumes to be metered can be freely selected. The dual syringe module includes holders for receiving two syringes. An adapter is provided for the corresponding syringe type. This dual syringe module has four linear axes, allowing the piston of the syringes as well as the syringes to travel in a vertical direction.

The vessel agitation module 182 includes a rotatable gripping device for mixing the solution. The reaction vial can be picked up, rotated with a variable angle (up to 180°) and with a variable speed, and subsequently be lowered on the vessel transport axis. The heater module 183 includes an integrated heating device for heating the solution to temperatures up to 100° C.

FIG. 6 illustrates the layout of a modular synthesis system for the production of 68Ga-DOTA conjugated peptides. The system consists of a module for holding vessels 190, three different valve modules (valve bank 191, magnetic valve 192, single valve 193), a reactor module 194 and a hose pump. The operation is described in Example 5.

FIG. 7 depicts an exemplary user interface of the hardware configuration illustrated in FIG. 1.

The invention will now be described for a special case of a modular system consisting of synthesis modules and a filling unit for use in radiopharmaceutical (or radiochemical) environments, which is administered by a common software user interface. It has the following major aspects:

### Flexibility

The process-related basic operations are realized in individual modules and/or components having a spatial arrangement that is freely configurable by the user. Different configurations can be realized depending on the task. For example, an additional reactor module 1 can be added for an additional synthesis step. In an exemplary embodiment, reactors with a reactor space ranging from 0.5 to 20 ml can be used.
The system enables both sterile operation by using sterilized one-way components, particularly suitable for routine production, as well as flexible research and multiplexed operation by using reusable components.
Components, such as reactors, valves, etc., can be expanded and retrofitted, and components can be rearranged.
A freely configurable, graphic user interface forms the basis.

### Basic Technical Features of the Invention are:

The process-related components or modules have standard modular dimensions, so that they can be combined into systems, either next to each other or on top of each other.
Liquid nitrogen, which has been used to date for cooling the reactor, is replaced by controllable electric cooling elements. This allows a more precise temperature control and eliminates handling of liquid nitrogen in the hot cell.
An intelligent bus system is provided to which the components, such as reactors, valves, etc., are connected, which are then automatically recognized by the system. This eliminates cumbersome registration and hardware-specific programming of added or changed components. The actual hardware configuration is always known to the software user interface.

### Modules and Components Include, Inter Alia:

Valve module: 2-way/3-way magnetic valves 6, squeeze-valve technology (squeeze-valve 5) or motor-driven valves and/or motor driven valve cocks or valve banks 3
Vessel module 4: for placing/holding of small flasks, for example for source materials
Vessel module in an active embodiment with interfaces for connecting external sensors and devices
Distribution module: for distributing/combining hose lines, partially in combination with valves or implemented with multiple-way valves
Reactor module 1: includes reactor vessel, heating/cooling, stirrer, activity measurement, observation camera
Cartridge module 2: for placing/holding filter, chromatography or extraction cartridges, separation columns, in part combined with valves or small flasks
Cold-trap module 8: to ensure that solvent and activity do not reach the vacuum pump 9
Vacuum/pressure system: the solution is transported to the lines by vacuum or overpressure
Metering module 10: for metering fluid volumes, consisting of one or more syringes moved by linear drives, or of a hose or piston pump and the like,
Accessories: (analytic units, such as HPLC 7, etc., or transition to filling station, . . . )

The components have the following common features:
Uniform modular dimensions of the modules for flexible configuration, for example as stackable boxes with modular dimensions
connectable and controllable via an intelligent bus system
disinfectable, suitable for aseptic operation
optionally, one-way components can be attached to the basic modules

### Software User Interface:

The software is used for:
configuring components of the synthesis and filling system,
programming the user interface/process protocol and the control flow,
operation and monitoring,
data storage/logging, and
administration.

The user interface meets the following general requirements:
Unrestricted, graphics-based programmability,
expandability,
standard reactions (e.g., F18-FDG) can be provided in preformatted form,
new reactions are provided to the customers as updates.

The software has the following tangible features:
Intuitive graphic programming environment.
The software is simple and clearly laid out and is configured for the target group as a technology packet.
The software includes the components required for configuration, programming and operation.
Uniform database for configuring the software of the system as an image of the hardware configuration (see FIG. 7 in conjunction with FIG. 1 or 2); hardware expansion is possible.
Programming of the user interface/process protocol of the system is implemented with functional components (functional blocks), programming of the control flow can be realized with functional components (functional blocks) or with text (table or script language).
Components are provided for the control and operation/display for components such as valves, pumps, reactors, filters, stirrers, analytic units . . . ; for each of these components of the system there is provided a component with control functionality and a component with display/operational functionality.
The display components have suitable dynamic visualization characteristics.
Programming of the control flow is accomplished with a suitable descriptive language (step sequence, program flowchart or script language).
A macro recorder allows generation of individual segments of the control flow (e.g., for emptying, cleaning . . . ). A dialogue window, which prompts that parameters required for the process flow be entered, is opened by simply clicking on the component(s). After acknowledgement, the process step is immediately inserted into the sequence of program steps in form of a graphic symbol. The macros are reusable and can be used repeatedly when programming the control flow, so that the control program remains clearly laid out to the user. Macros or executable programs can be selectively generated. When using generated programs, the programmed sequence can advantageously be immediately executed.
Process flows that have already started can be concluded in manual mode if hardware or software malfunctions.
Malfunctions, errors or other relevant events are displayed in message windows.
The software conforms to the guideline U.S. FDA 21 CFR Part 11 which regulates electronic data administration and the use of electronic signatures.
If the process changes and/or components are added/removed, the software permits simple reconfiguration of the system and reprogramming of the control flow and the user interface.
Each change in an application (relating to changes in the parameters and/or program) is stored (traceability).

### Filling Module:

The filling module has the following features:
Can be used with the same software as used with the synthesis modules, so that both modules are fully compatible,
Commercially available partial solutions can be integrated,
Through the use of corresponding adapters, different vial geometries and syringes can be filled at the filling station,
Suitability for aseptic operation.

The invention will be described hereinafter with reference to three typical exemplary embodiments suitable for application in a radiopharmaceutical setting.

### EXAMPLE 1

### Modular Synthesis System for Producing ¹⁸F-FDG (2-deoxy-2-fluoro-D-glucose)

A system for the synthesis of the PET tracer ¹⁸F-FDG can be assembled, for example, from four modules 111, 112, 113, 114 that hold vessels or cartridges, six valve modules 121, 122, 123, 124, 125, 126 (each having three valves), a reactor module 130 and a module 144 producing a vacuum (vacuum pump with cold-trap 150 and filter). The media can either be transported with sterile one-way components, or a fixed installation for multiple use can be realized.

The four modules 111, 112, 113, 114 holding vessels or cartridges are each connected with a corresponding valve module 121, 122, 123, 124, 125, and 126 to form a functional unit for controlling the flow of the medium. The first functional unit 111, 121 with two vessels and one cartridge separates the ¹⁸-fluoride coming from the cyclotron from water and transfers the material to the reactor in an aprotic solvent. The second functional unit 112, 122 includes three vessels for adding the required reactants and solvents to the reactor. In the reactor module 130, all three reactions steps, such as azeotropic distillation, nucleophilic substitution and separation of the protective groups are performed. For cleaning the product, the raw product can be selectively transferred via a valve module 125 by way of an HPLC separation process to the third functional unit 113, 123. The third functional unit includes a vessel for catching the solution received from the HPLC unit 160, a cartridge for separating the product from the HPLC solvent and a vessel for the end product. The HPLC separation process is not required for routine production and is mentioned here only for sake of completeness of the synthesis system. The fourth functional unit 114, 124 includes three vessels for adding the required solutions for cleaning, elution from the cartridge and dilution of the product. The solutions are transported by applying an overpressure or an underpressure at specified locations of the system by a vacuum module 140 under control of a valve module 126. All reactions steps as well as cleaning and separation of reaction residues are performed fully automatically, yielding a product ready for filling.

### EXAMPLE 2

### Modular Synthesis System for the Preparation of Zevalin®

A system for the preparation of Zevalin® from the Zevalin® kit includes a module for holding vessels, two valve modules (valve bank), a metering module, a reactor module and a module for producing a vacuum (vacuum pump with filter). For transporting the medium, the individual components are connected by hoses, which are connected via quick-connects either to needles, which are pierced into the vessel covers having a septum, or directly to stopcocks, valves. All these are sterile one-way components, which are disposed after the reaction. A defined amount of radioactive solution is added to the reaction vessel by measuring the radioactivity in the reactor module. Corresponding quantities of the inactive reactants are metered from the vessels into the reaction vessel via a valve module and the metering module. The required quantities, the sequential order and the temporal progression of the addition are computed and controlled by the controlling computer by using the aforedescribed software. The solutions are transported and intermixed by applying an overpressure or underpressure at the specified locations of the system with a module that generates the vacuum and is controlled by a valve module.

### EXAMPLE 3

### Modular Synthesis System for the Preparation of Tc-99m-MIBI

A system for the preparation of Tc-99m-MIBI from the Tc-99m-MIBI kit includes a module for holding vessels, a valve module (valve bank), a reactor module and a module generating vacuum (vacuum pump with filter). For transporting the medium, the individual components are connected with hoses, which are connected via quick-connects either to needles, which are pierced into the vessel covers having a septum, or directly to stopcocks, valves. All these are sterile one-way components, which are disposed after the reaction. The small flask from the kit with Tc-99m-MIBI is inserted into the reactor block and radioactive solution is added. The solutions are transported and intermixed by applying an overpressure or underpressure in the reaction vessel with a module that produces the vacuum and is controlled by a valve module. For carrying out the synthesis, the reactor is heated and at the end of the reaction again cooled down to room temperature. The temperature is controlled by the controlling computer using the aforedescribed software.

### EXAMPLE 4

### Modular System, Based on a Syringe Module, for the Preparation of Tc-99m-MIBI

A system for the preparation of Tc-99m-MIBI from the Tc-99m-MIBI kit includes a module for holding, transporting and activity measurement of vessels, a syringe module, a vessel agitation module, as well as a heater module. First, the required syringes are inserted and affixed in the syringe module. The reaction vial from the kit and the vial with the activity are placed in the provided holders in the vessel transport module. The activity vial is moved underneath the left syringe in the syringe module and the activity is drawn in from the activity vial. The reaction vial then moves onward to the left syringe and the activity is added to the reaction vial. The dosage is monitored by the detector. The reaction vial subsequently moves to the vessel agitation module where it is received with the gripper and agitated. After agitation, the heating device of the heater module moves underneath the vessel which is still gripped, and the reaction vial is placed into the heating device. After heating, the reaction vial is returned to the holder of the vessel transport module and transported after cooling to the removal position.

### EXAMPLE 5

### Modular Synthesis System for the Production of ⁶⁸Ga-DOTA Conjugated Peptides

A system for the preparation of ⁶⁸Ga-DOTA conjugated peptides includes a module for holding vessels 190, three different valve modules (valve bank 191, magnetic valve 192, single valve 193), a reactor module 194 and a hose pump. The hose pump supplies the radioactive ⁶⁸gallium solution from a generator to the valve module (magnetic valve 192). This valve module controls the addition of the ⁶⁸gallium solution to the reactor 194, where the ⁶⁸gallium solution is reacted with the provided reactants to the product by heating. The raw product is transported via the valve module (magnetic valve 192) to the valve module (single valve 193), where the product is cleaned and sterile-filtered by using an adsorption cartridge 195 and a sterile filter 196. These components as well as all the following hoses, valves and connections are sterile one-way parts which are disposed after the reaction. The finished product is transported to a sterile delivery vessel 197 disposed on the module that holds vessels.

The medium is transported (with the exception of the ⁶⁸gallium solution) by an externally applied pressure. The pressure conditions in the system are controlled via the valve module (valve bank 191).

The system includes a test for checking the integrity of the sterile filtration and a fully automatic cleaning procedure for all permanent components that come into contact with the medium.

The embodiment of the invention is not limited to the aforedescribed preferred exemplary embodiments. Instead, a number of variants can be contemplated which make use of the system and method of the invention even when using entirely different embodiments.

### LIST OF REFERENCE SYMBOLS

1 reactor module
2 cartridge module
3 valve module in an embodiment valve bank
3a valve module in the embodiment 3 individual 3-way valves
4 vessel module
5 valve module in an embodiment squeeze-valve
6 valve module in an embodiment 3-way/2-way valve
7 accessory/analytic unit, here HPLC
8 cold-trap module
9 vacuum/pressure system, here vacuum pump with valves
10 metering module (syringe module)
111 module for holding vessels and cartridges
112 module for holding vessels and cartridges
113 module for holding vessels and cartridges
114 module for holding vessels and cartridges
121 valve module in an embodiment 2-way magnetic valve
122 valve module in an embodiment 2-way magnetic valve
123 valve module in an embodiment 2-way magnetic valve
124 valve module in an embodiment squeeze-valve
125 valve module in an embodiment valve bank
126 valve module in an embodiment valve bank
130 reactor module
140 vacuum module, module for producing vacuum
150 cold-trap
160 HPLC unit
180 vessel transport module, including activity detector
181 syringe module (here in an embodiment as a dual syringe module)
182 vessel agitation module
183 heater module
190 module for holding
191 valve module in an embodiment valve bank
192 valve module in an embodiment 3-way/2-way valve, in addition vessel holder applied on the side
193 valve module in the embodiment 3 individual 3-way valves, in addition vessel holder applied on the side
194 reactor module
195 adsorption cartridge
196 sterile filter
197 sterile delivery vessel

1-29. (canceled)

30. System for processing chemical substances in a laboratory environment comprising:
components for performing chemical processing operations, wherein the components are combinable in modular form according to a presettable sequence of process steps for processing at least a first chemical substance, wherein the processing includes synthesis of at least a second chemical substance and at least partially automatically controlling at least one of the components, and
wherein the components have matching modular dimensions and are implemented as stackable, self-supporting boxes.

31. System according to claim 30,
characterized in that
at least one of the first and chemical substances is a radioactive substance.

32. System according to claim 30,
characterized in that
the second chemical substance is at least one of a pharmaceutical product and a diagnostic product.

33. System according to claim 30,
characterized in that the
components include a component for filling and a component for performing a basic chemical processing operation.

34. System according to claim 30,
characterized in that
the chemical processing operations comprise at least one of
transport of vials/syringes,
filtration,
heating/cooling,
filling,
emptying,
dosing,
dispensing,
mixing,
diluting,
stirring,
agitation,
extraction,
ion exchange,
chromatography, in particular HPLC,
detection of product properties,
evaporating,
boiling,
rinsing and cleaning, and
generation of underpressure or overpressure.

35. System according to claim 30,
characterized in that the components are combinable to perform at least one of the process steps of:
sterile filtration,
determination of the integrity of a sterile filter,
labeling,
packaging and
filling.

36. System according to claim 30,
characterized in that
the components are implemented as at least one of a
valve module,
vial module,
vial transport module,
vial agitation module,
cartridge module,
distribution module,
reactor module,
heater module,
dosing/dispensing module, for example a syringe module,
HPLC unit,
cold-trap module,
vacuum system
overpressure system,
filling module, and
analytic device.

37. System according to claim 30,
characterized in that the components are in a modular combination such that: (i) a first of the components is exchangeable with a second of the components for replacing a process step in the sequence of process steps; or (ii) a third of the components is insertable into the combination for adding a process step to the sequence of process steps.

38. System according to claim 37,
characterized in that the
components are connectable in a linear arrangement via an intelligent bus system.

39. System according to claim 38,
characterized in that the
components are combinable with one another at any location of a line.

40. System according to claim 30,
characterized in that the sequence of process steps includes reactor cooling and a first of the components performs the reactor cooling without using liquid nitrogen.

41. System according to claim 38,
characterized in that
the intelligent bus system automatically recognizes the connected components.

42. System according to claim 30,
characterized in that
at least one of the components are combinable with a single-use element.

43. Method for processing chemical substances in a laboratory environment by using components for performing chemical processing operations comprising;
providing components implemented as stackable, self-supporting boxes and having matched modular dimensions, wherein the components are modularly combinable;
configuring the components into a modular combination according to a preset sequence of process steps for processing at least a first chemical substance; and
processing the at least first chemical substance with the modularly combined components, wherein the processing is at least partially automatically controlled and synthesizes a second chemical substance.

44. Method according to claim 43,
characterized in that the configuring and the automatic controlling are performed under a common software user interface.

45. Method according to claim 43,
characterized in that
at least a first of the components is employed in a sterile operation in the processing, and the first component is at least one of a sterilized single-use component and a reusable component.

46. Method according to claim 43,
characterized in that the automatic controlling is performed by a computer program encoded on a computer readable medium, and wherein the computer program uses a uniform database stored in a memory for the configuring of the components.

47. Method according to claim 43,
characterized in that the automatic controlling is performed by a computer program encoded on a computer readable medium and provides a mode for manual control of the processing.

48. Method according to claim 43,
characterized in that at least one of the components is combined with a filling module and the processing includes at least one of filling of vial geometries and syringes by using an adapter.

49. A computer-readable medium encoded with a computer program executable by a computer, wherein the program includes steps of a process for processing at least a first chemical substance in a laboratory environment by using components for performing chemical processing operations, wherein the components are combinable in a modular combination and are implementable as stackable, self-supporting boxes having matched modular dimensions, wherein the process comprises;
configuring the components in a modular combination according to a preset sequence of process steps for processing at least a first chemical substance; and
processing the at least first chemical substance with the modularly combined components, wherein the processing is at least partially automatically controlled by the computer and synthesizes a second chemical substance.

50. The method of claim 49, wherein the computer program is downloaded from an electronic data network.

51. The method of claim 50, wherein the network is the Internet.

52. The method of claim 50, wherein the medium is connected to the data network.
